(19) United States
(12) Patent Application Publication
(10) Pub. No.: US 2022/0239979 A1
(43) Pub. Date: Jul. 28, 2022

(54) SYSTEMS AND METHODS FOR ESTABLISHING COMMUNICATIONS BETWEEN COMPUTING SYSTEMS

(71) Applicant: Meta Platforms, Inc., Menlo Park, CA (US)

(72) Inventors: Abhinav Rajeev Jain, San Francisco, CA (US); Cam Thach Nguyen, Mountain View, CA (US); Felix Leupold, Berlin (DE); Bjoern Alexander Lin Ryden Blom, London (GB)

(21) Appl. No.: 16/172,585

(22) Filed: Oct. 26, 2018

(51) Int. Cl. H04N 21/442; H04N 21/262; H04N 21/254; H04N 21/431

(52) U.S. Cl. CPC H04N 21/44213; H04N 21/26283; H04N 21/4788; H04N 21/254; H04N 21/431; H04N 21/44204

(57) ABSTRACT

Systems, methods, and non-transitory computer-readable media can receive information describing one or more viewed media content items from a plurality of computing devices. Each computing device can communicate with the computing system over a persistent network connection. The information describing the one or more viewed media content items received from the plurality of computing devices can be aggregated. The aggregated information can be used to re-rank a set of media content items for one or more users.

### FIELD OF THE INVENTION

The present technology relates to the field of computer networking. More particularly, the present technology relates to techniques for establishing communications between computing systems.

### BACKGROUND

Today, people often utilize computing devices (or systems) for a wide variety of purposes. Users can use their computing devices to, for example, interact with one another, access content, share content, and create content. In some cases, media content items can include postings from members of a social network. The postings may include text and media content items, such as images, graphical interchange formats (GIFs), videos, and audio. The postings may be published to the social network for consumption by others.

### SUMMARY

Various embodiments of the present technology can include systems, methods, and non-transitory computer readable media configured to receive information describing one or more viewed media content items from a plurality of computing devices. Each computing device can communicate with the computing system over a persistent network connection. The information describing the one or more viewed media content items received from the plurality of computing devices can be aggregated. The aggregated information can be used to re-rank a set of media content items for one or more users.

In some embodiments, the information describing the one or more viewed media content items can include a respective viewport view duration for each media content item and a corresponding computing device through which the media content item was accessed.

In some embodiments, a viewport view duration for a media content item can be determined based on an amount of time the media content item was positioned within a viewport region within a display screen of a computing device.

In some embodiments, the information describing the one or more viewed media content items can include a respective viewport view duration for at least one comment associated with a media content item and a corresponding computing device through which the comment was accessed.

In some embodiments, a viewport view duration for a comment can be determined based on an amount of time the comment was positioned within a viewport region within a display screen of a computing device.

In some embodiments, the information describing the one or more viewed media content items can identify respective content types for the media content items.

In some embodiments, a content type can identify a media content item as an image, video, looping video, or audio.

In some embodiments, the persistent network connection can be implemented as an RSocket connection.

In some embodiments, the persistent network connection between a computing device and the computing system can allow the computing device to communicate information to the computing system as media content items are viewed.

In some embodiments, the aggregated information can be used to filter a set of media content items for one or more users.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system, according to an embodiment of the present technology.

FIG. 2 illustrates an example client module, according to an embodiment of the present technology.

FIG. 3 illustrates an example content provider module, according to an embodiment of the present technology.

FIG. 4A illustrates an example diagram, according to an embodiment of the present technology.

FIG. 4B illustrates example aggregated viewport information, according to an embodiment of the present technology.

FIG. 4C illustrates an example interface, according to an embodiment of the present technology.

FIG. 4D illustrates another example interface, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Establishing Communications Between Computing Systems

People often utilize computing devices (or systems) for a wide variety of purposes. Users can use their computing devices to, for example, interact with one another, access content, share content, and create content. In some cases, media content items can include postings from members or users of a social network. The postings may include text and media content items, such as images, graphical interchange formats (GIFs), videos, and audio. The postings may be published to the social network for consumption by others.

In general, users can access and interact with various media content items through a social networking system. Often, information describing user interactions with media content items can be used to gain insight into user interests and preferences. Such insight can be used for myriad purposes. For example, the social networking system can refine the types of media content items that may be suggested to a given user based on that user's previous interactions with media content items. In general, a user can access media content items from the social networking system using an application (e.g., a social networking application) running on a computing device. As the user browses content, the computing device can send information (e.g., viewport information) describing viewed media content items and the user's interactions with the media content items to the social networking system. The viewport information can include, for example, a respective view duration during which the user viewed a given media content item, the media content item type, and interaction data. Under conventional approaches, when sending viewport information to the social networking system, the computing device batches and sends the information at periodic intervals or upon request by the social networking system. These existing approaches pose a number of disadvantages. For example, under conventional approaches, the software application running on the computing device typically instructs the computing device to batch and send viewport information to the social networking system. However, this information may not successfully be transmitted to the social networking system if the software application crashes during batching or transmission. As a result, viewport information describing user activity can be lost and unrecoverable. Another disadvantage with conventional approaches is that such approaches rely on computing devices to individually batch and store viewport information. Such approaches, therefore, can tax device resources that could otherwise be used to improve user experience.

An improved approach rooted in computer technology overcomes the foregoing and other disadvantages associated with conventional approaches specifically arising in the realm of computer technology. In various embodiments, a user can access content through a social networking system using a software application (e.g., a social networking application) running on a computing device. When launched, the software application instructs the computing device to establish a persistent network connection with the social networking system over one or more networks (e.g., the internet). The computing device can use this persistent network connection to send (or transmit) viewport information to the social networking system. Such viewport information can describe user interactions with media content items that are accessed through the social networking system, for example. In various embodiments, the computing device can send such viewport information in real-time (or near real-time) while media content items are being accessed by a user operating the computing device. This improved approach thus relieves the computing device from having to batch and send viewport information to the social networking system. Instead, the viewport information is sent to the social networking system and then efficiently batched by one or more computing systems associated with the social networking system. In some embodiments, viewport information for a media content item can be sent to the social networking system as soon as the media content item is accessed. The improved approach also helps prevent data loss since viewport information is sent to the social networking system in real-time (or near real-time) without requiring computing devices to store viewport information for extended periods of time. Although the examples herein refer to communicating and batching viewport information, the approaches described may be adapted for any type of data (e.g., logged data) that can be communicated and batched.

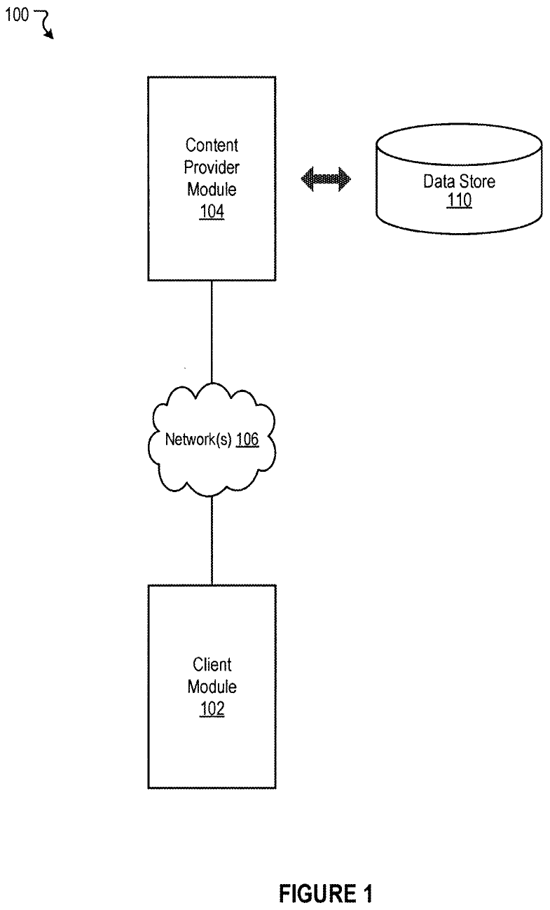

FIG. 1 illustrates an example system 100, according to an embodiment of the present technology. As shown in the example of FIG. 1, the example system 100 can include a client module 102 and a content provider module 104. In some instances, the example system 100 can include at least one data store 110. The client module 102 can interact with the content provider module 104 over one or more networks 106 (e.g., the internet, a local area network, a cellular network, etc.). In various embodiments, the one or more networks 106 can be any wired or wireless computing network through which devices or computing systems can exchange data. For example, the one or more networks 106 can be a personal area network, a local area network, or a wide area network, to name some examples. The components (e.g., modules, elements, etc.) shown in this figure and all figures herein are exemplary only, and other implementations may include additional, fewer, integrated, or different components. Some components may not be shown so as not to obscure relevant details.

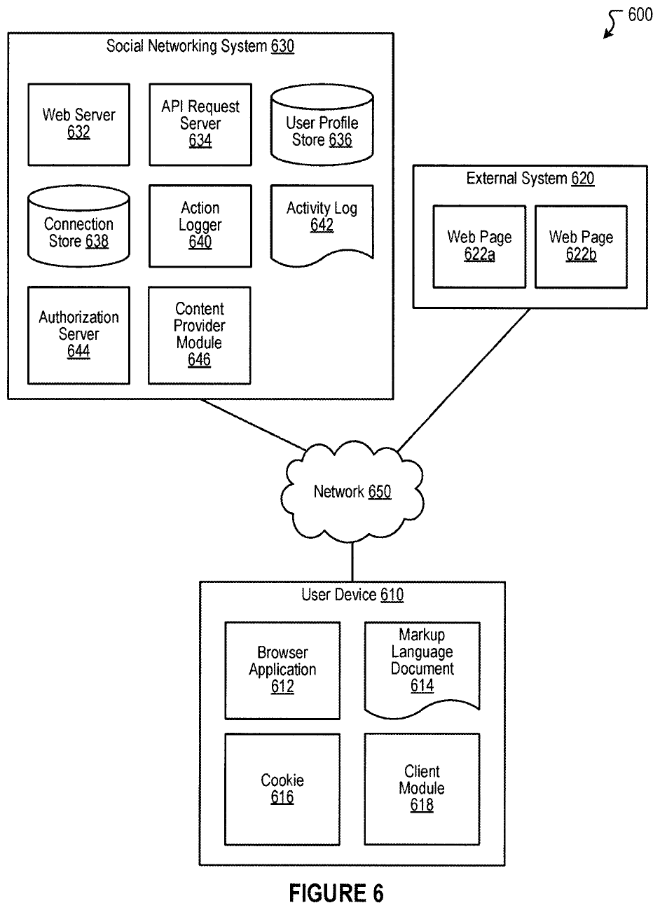

In some embodiments, the client module 102 and the content provider module 104 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the client module 102 and the content provider module 104 or at least a portion thereof can be implemented using one or more computing devices or systems that include one or more servers, such as network servers or cloud servers. In some instances, the client module 102 and the content provider module 104 can, in part or in whole, be implemented within or configured to operate in conjunction with a social networking system (or service), such as the social networking system 630 of FIG. 6. In some instances, the client module 102 can be, in part or in whole, implemented within or configured to operate in conjunction or be integrated with a client computing device, such as the user device 610 of FIG. 6. The client module 102 and the content provider module 104 can be implemented as or within a dedicated application (e.g., app), a program, or an applet running on a user computing device or client computing system. The application incorporating or implementing instructions for performing some, or all, functionality of the client module 102 and the content provider module 104 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

In some embodiments, the content provider module 104 can be configured to communicate and/or operate with the at least one data store 110, as shown in the example system 100. The at least one data store 110 can be configured to store and maintain various types of data. For example, the at least one data store 110 can store information describing various content that has been viewed, accessed, or consumed by users of a social networking system. In some implementations, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data.

In various embodiments, the client module 102 can be configured to interact with the content provider module 104 over the one or more networks 106. For example, in some embodiments, the client module 102 can be implemented in a computing device, such as the user device 610 of FIG. 6. In some embodiments, the client module 102 can be implemented in a software application (e.g., a social networking application) running on a computing device, such as the user device 610 of FIG. 6. The content provider module 104 can be implemented in one or more computing systems, such as the social networking system 630 of FIG. 6. In some embodiments, the client module 102 can determine information (e.g., viewport information) describing media content items that are viewed by a user operating the computing device. For example, the media content items may be viewed in one or more content feeds that are provided by the content provider module 104. The client module 102 can then send the determined information to the content provider module 104 for further processing. Some examples of the types of information that may be determined and sent to the content provider module 104 include types of media content items that were viewed by the user (e.g., images, videos, audio, texts, etc.), respective durations of time over which the media content items were viewed, and types of user interactions applied to media content items (e.g., like, comment, share, etc.), to name some examples. In some embodiments, the content provider module 104 can use such information to rank media content items. For example, media content items to be presented to a given user can be ranked based on viewing habits of the user. In some embodiments, the content provider module 104 can use such information to filter media content items. For example, media content items that have been viewed by a user can be prevented from again being shown to the user.

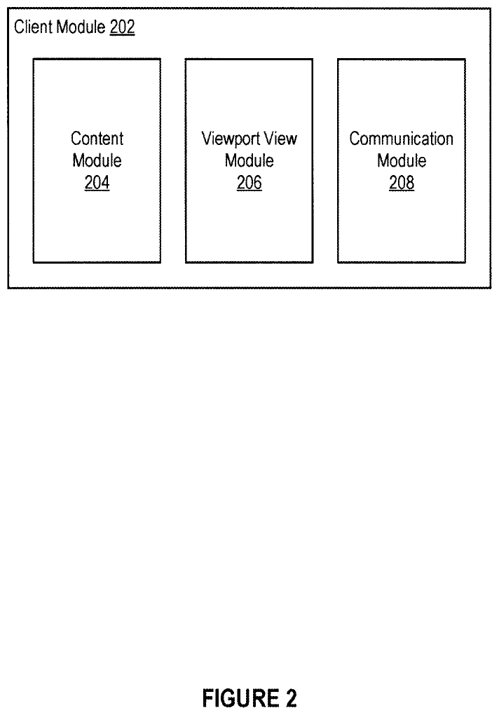

FIG. 2 Illustrates an example client module 202, according to an embodiment of the present technology. In some embodiments, the client module 102 of FIG. 1 can be implemented as the client module 202. For example, the client module 202 can be configured to access media content items posted through a social networking system (e.g., the social networking system 630 of FIG. 6). Further, the client module 202 may be implemented as or within a software application (e.g., a social networking application) running on a computing device, such as the user device 610 of FIG. 6. As shown in FIG. 2, the client module 202 can include a content module 204, a viewport view module 206, and a communication module 208.

The content module 204 can be configured to provide access to media content items that are published through the social networking system. For example, the content module 204 can provide access to media content items through a graphical user interface. The interface may be presented through a display screen of the computing device. A user operating the computing device can interact with the interface using various touchscreen gestures or an external apparatus, for example. In some embodiments, the interface can include options for viewing and interacting with media content items. For example, the interface can include options for liking (or endorsing) a media content item, posting a comment in response to the media content item, and sharing the media content item.

The viewport view module 206 can be configured to determine viewport information for media content items that are accessed through the computing device. The determined viewport information can then be sent to the social networking system for further processing. For example, in various embodiments, the viewport view module 206 can determine viewport information for each media content item that is accessed through the social networking system. In some embodiments, viewport information for a media content item can include a view duration that measures an amount of time the media content item was accessed (or viewed) by the user operating the computing device. For example, the view duration can be determined based on an amount of time the media content item is positioned within a viewport region of the interface. The viewport region may correspond to a pre-determined region of the interface and/or the display screen of the computing device on which the media content item is being accessed. For example, the viewport region may be defined by a specified set of pixel coordinates that correspond to the display screen of the computing device through which the interface is being accessed. Depending on the implementation, the pre-determined region may generally correspond to the top, middle, or bottom of the display screen. In some implementations, the pre-determined region may vary depending on the make, model, and/or type of computing device being used to access the interface. In some embodiments, a view duration for a media content item can be determined based on an amount of time the media content item was positioned within the viewport region. In some embodiments, some media content items (e.g., videos, looping videos, audio, etc.) can begin playing as soon as those media content items are positioned within the viewport region of the interface for a threshold time duration. In such embodiments, a view duration for a media content item is measured from the time the media content item begins playing to when the media content item stops playing or when the media content item is no longer being presented within the viewport region. For example, the media content item may cease playing when the media content item has completed its playback, when the user selects an option to end playback of the media content item, or when the user accesses a different media content item. In some embodiments, viewport information for a media content item can include a content type classification for the media content item. For example, the viewport information can identify the media content item as an image, video, looping video, or audio, to name some examples. In some embodiments, viewport information for a media content item can identify user interactions that were performed with respect to the media content item. For example, the user operating the computing device may select options to interact with a media content item (e.g., like, comment, share, etc.). In such embodiments, information describing the options selected can be included in the viewport information. In some embodiments, viewport information can be determined for comments associated with media content items. For example, in addition to accessing media content items, the user operating the computing device can also access respective comments that were posted in response to those media content items. In such embodiments, a view duration for a comment can be determined based on an amount of time the comment was positioned within the viewport region. Similarly, user interactions with comments can also be determined and stored as viewport information.

The communication module 208 can be configured to communicate with the social networking system over various computing networks (e.g., the internet). In various embodiments, the communication module 208 can establish a persistent network connection with the social networking system. The persistent network connection provides a dedicated channel over which viewport information can be sent to the social networking system in real-time (or near real-time). In some embodiments, the persistent network connection can be established by a computing device upon executing a software application in which the client module 202 is implemented. For example, once the software application is launched, the communication module 208 can instruct the computing device to establish a persistent network connection with the social networking system. In this example, the persistent network connection allows the computing device to send viewport information to the social networking system when media content items are viewed and logged through the computing device. In other words, the computing device need not batch and send viewport information to the social networking system. Rather, viewport information for a given media content item can be sent as soon as the viewport information is determined by the computing device. The persistent network connection permits transmission of viewport information on an on-going basis without having to establish separate network connections each time viewport information is ready to be sent to the social networking system. In some embodiments, the persistent network connection can be implemented as a reactive socket (RSocket). In general, RSocket is a binary protocol for use on byte stream transports such as Transmission Control Protocol (TCP) and WebSockets. RSocket can be used to implement symmetric interaction models via asynchronous message passing over a single network connection. In some embodiments, RSocket is layered on top of HyperText Transfer Protocol 2.0 (HTTP2).

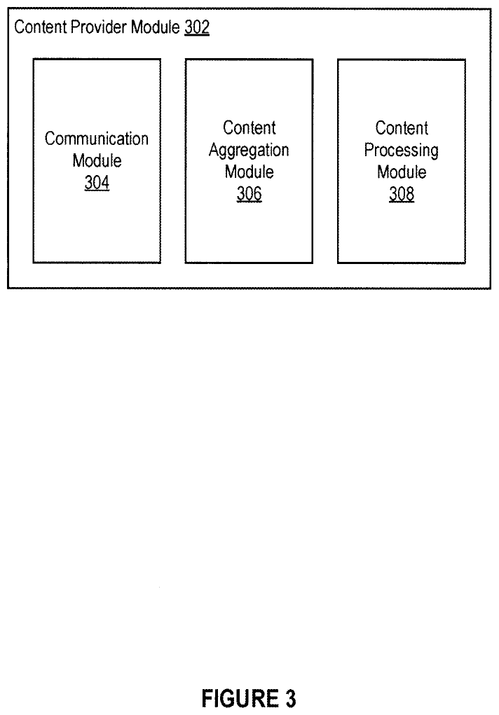

FIG. 3 illustrates an example content provider module 302, according to an embodiment of the present technology. In some embodiments, the content provider module 104 of FIG. 1 can be implemented as the content provider module 302. The content provider module 302 can be configured to provide users with access to media content items that are published through the social networking system. As shown in FIG. 3, the content provider module 302 can include a communication module 304, a content aggregation module 306, and a content processing module 308.

The communication module 304 can be configured to communicate with computing devices over various computing networks (e.g., the internet). In various embodiments, the communication module 304 can establish a persistent network connection with a computing device as described above. For example, the computing device may send a request to establish the persistent network connection (e.g., RSocket) with the social networking system. The communication module 304 can then establish the persistent network connection with the computing device. Once established, the computing device can use the persistent network connection to send viewport information to the social networking system. The communication module 304 can receive and cause such viewport information to be stored. In some embodiments, the communication module 304 can be configured to batch viewport information. For example, the communication module 304 can batch the viewport information received from computing devices prior to storing such viewport information. In general, such batching can help improve data storage efficiency and management.

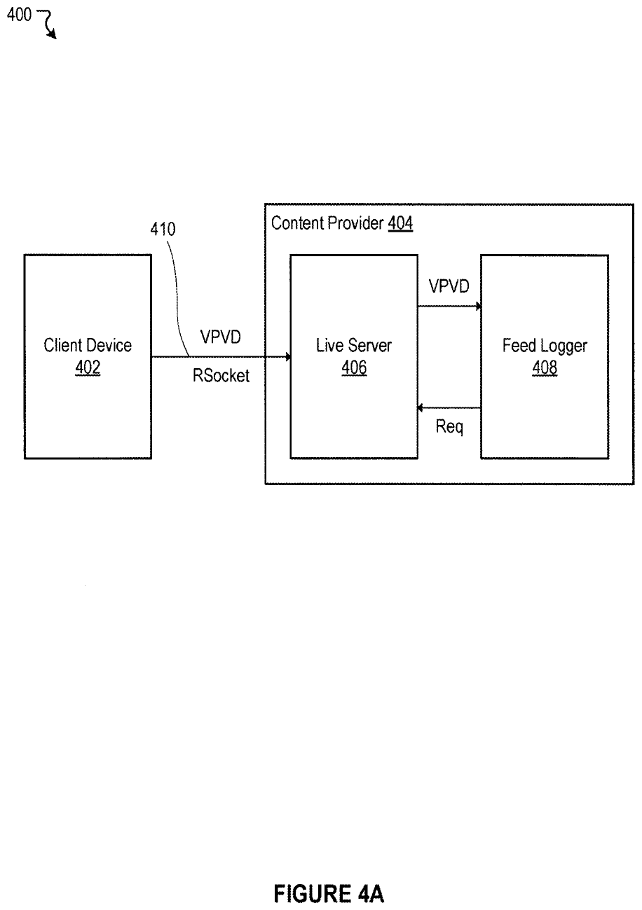

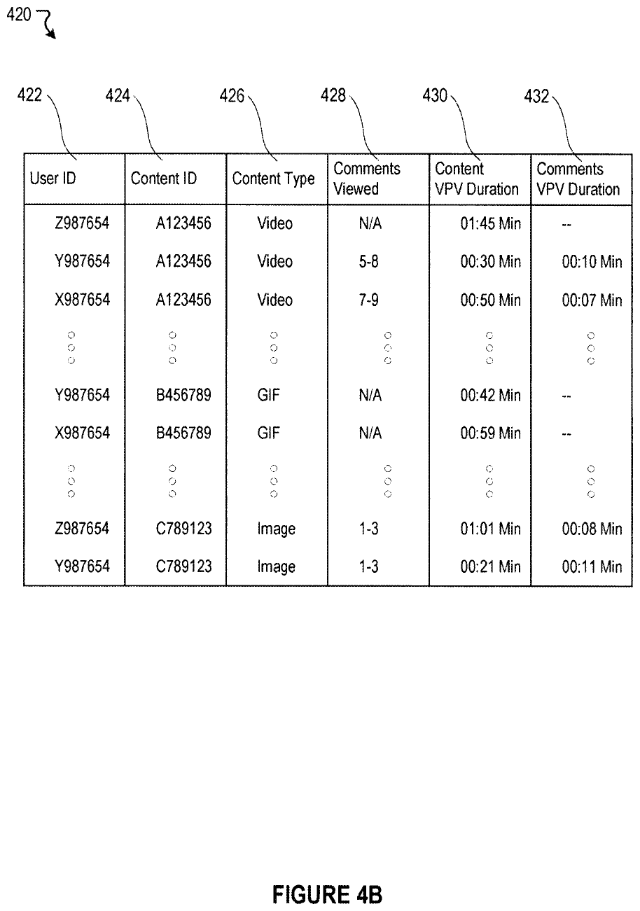

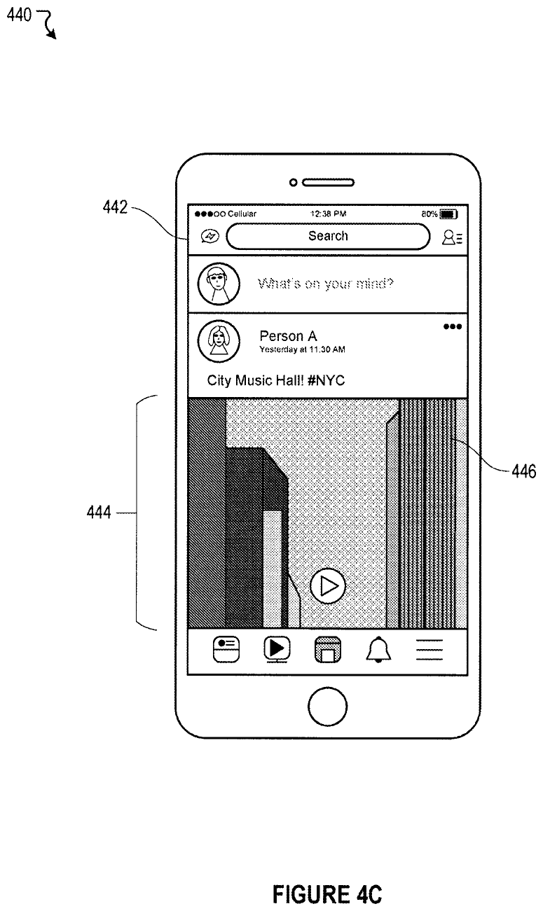

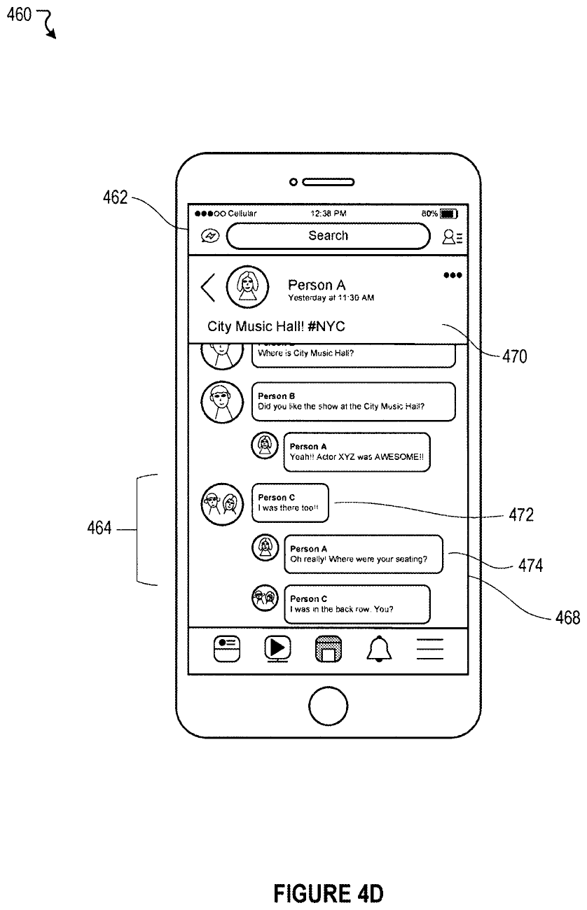

The content aggregation module 306 can be configured to aggregate viewport information that is received from computing devices in real-time (or near real-time). For example, a user operating a computing device may access many media content items during a session. During this session, the computing device may also send viewport information for the accessed media content items to the social networking system. When such viewport information is received, the content aggregation module 306 can determine that the viewport information corresponds to media content items accessed by the user operating the computing device. The content aggregation module 306 can then associate the viewport information with the user, the computing device, or both, and then cause the viewport information and its association with the user, the computing device, or both to be stored. Many variations are possible. Further details describing the content aggregation module 306 will be discussed below with reference to FIG. 4B.

The content processing module 308 can be configured to modify presentation of media content items. In some embodiments, the content processing module 308 can rank (or re-rank) media content items for a given user based on viewport information describing media content items that were accessed by the user. For example, a user that accessed media content items of a particular content type for a threshold view duration can be shown more media content items that are of the same content type (e.g., images, videos, looping videos, etc.). In another example, a user that interacted with certain media content items can be shown additional media content items that are similar to the media content items with which the user interacted. In some embodiments, the content processing module 308 can filter media content items for a given user based on viewport information describing media content items that were accessed by the user. For example, a user that accessed a media content item without satisfying a threshold view duration can be shown fewer media content items that are similar to the media content item. In another example, a media content item that was already viewed by a user can be prevented from being shown to the user again. Many variations are possible.

FIG. 4A illustrates an example diagram 400, according to an embodiment of the present technology. In this example, the diagram 400 includes a client device 402 and a content provider 404. The content provider 404 includes a live server 406 and a feed logger 408. In an embodiment, the live server 406 can be configured to perform functionalities of the communication module 304, and the feed logger 408 can be configured to perform functionalities of the content aggregation module 306 and the content processing module 308 of FIG. 3. In various embodiments, a user can access media content items provided by the content provider 404 through an application (e.g., a social networking application) running on the client device 402. Upon execution or launching of the application, the client device 402 establishes a persistent network connection 410 (e.g., “RSocket”) with the live server 406. The client device 402 can use the persistent network connection 410 to send viewport information (e.g., “VPVD”) to the live server 406 as soon as the viewport information is determined. In this example, the feed logger 408 may send a request to the live server 406 to obtain the viewport information. The feed logger 408 can then aggregate and store the obtained viewport information, as described above. For example, the feed logger 408 can aggregate the obtained viewport information based on user identifier, content identifier, content type, viewed comments, view direction, and respective view durations for comments associated with the media content items. Based on this aggregated viewport information, the feed logger 408 can rank (or re-rank) media content items to be presented the user a next time the user accesses the content provider 404.

FIG. 4B illustrates example aggregated viewport information 420, according to an embodiment of the present technology. In this example, the aggregated viewport information 420 includes viewport information received from various computing devices (e.g., the client device 402 of FIG. 4A). In some embodiments, for each media content item accessed by a computing device, the aggregated viewport information 420 can include a user identifier 422, content identifier 424, content type 426, viewed comments 428, view duration 430, and respective view durations for comments associated with the media content item 432. Many variations are possible.

FIG. 4C illustrates an example interface 440, according to an embodiment of the present technology. In this example, the interface 440 is presented through a display screen 442 of a computing device. The interface 440 may be provided by a software application (e.g., a web browser, a social networking application, etc.) running on the computing device that is configured to interact with a social networking system. As shown, the interface 440 includes a media content item 446 (e.g., a video) being presented in a viewport region 444 within the interface 440. In some embodiments, the software application can log various viewport information for the media content item 446 being accessed including, for example, view duration, content type, and user interactions. A swipe gesture, for example, can cause a comment stream related to the media content item 446 to be displayed, as set forth below. Many variations are possible.

FIG. 4D illustrates another example interface 460, according to an embodiment of the present technology. In this example, the interface 460 is presented through a display screen 462 of a computing device. The interface 460 may be provided through a software application (e.g., a web browser, a social networking application, etc.) running on the computing device that is configured to interact with a social networking system. As shown, the interface 460 includes a comment stream 468 associated with a media content item 470. In this example, the software application can determine respective view durations for comments (e.g., comment 472, comment 474) that are positioned within a viewport region 464 within the interface 460. This viewport information can be logged and sent to the social networking system, as described above.

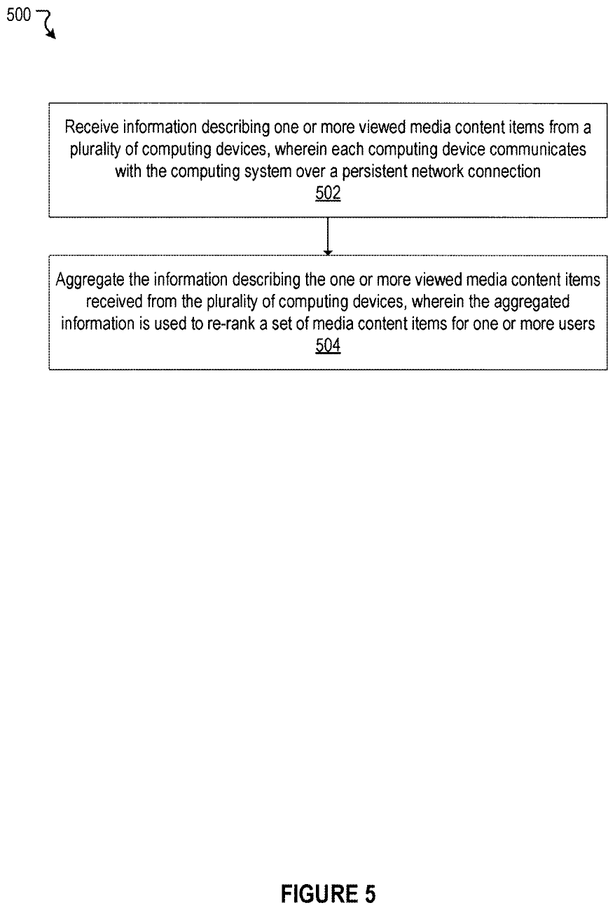

FIG. 5 illustrates an example method, according to an embodiment of the present technology. It should be appreciated that there can be additional, fewer, or alternative steps performed in similar or alternative orders, or in parallel, within the scope of the various embodiments discussed herein unless otherwise stated.

At block 502, information describing one or more viewed media content items can be received from a plurality of computing devices. Each computing device can communicate with the computing system over a persistent network connection. At block 504, the information describing the one or more viewed media content items received from the plurality of computing devices can be aggregated. The aggregated information can used to re-rank a set of media content items for one or more users.

It is contemplated that there can be many other uses, applications, and/or variations associated with the various embodiments of the present technology. For example, in some cases, user can choose whether or not to opt-in to utilize the disclosed technology. The disclosed technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, media content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and media content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can be implemented with the content provider module 104, as discussed in more detail herein. In some embodiments, one or more functionalities of the content provider module 646 can also be implemented in the user device 610.

In some embodiments, the user device 610 can include a client module 618. The client module 618 can be implemented with the client module 102 of FIG. 1. In some embodiments, the social networking system 630 can include a content provider module 646. The content provider module 646 can be implemented with the content provider module 104 of FIG. 1.

### Hardware Implementation

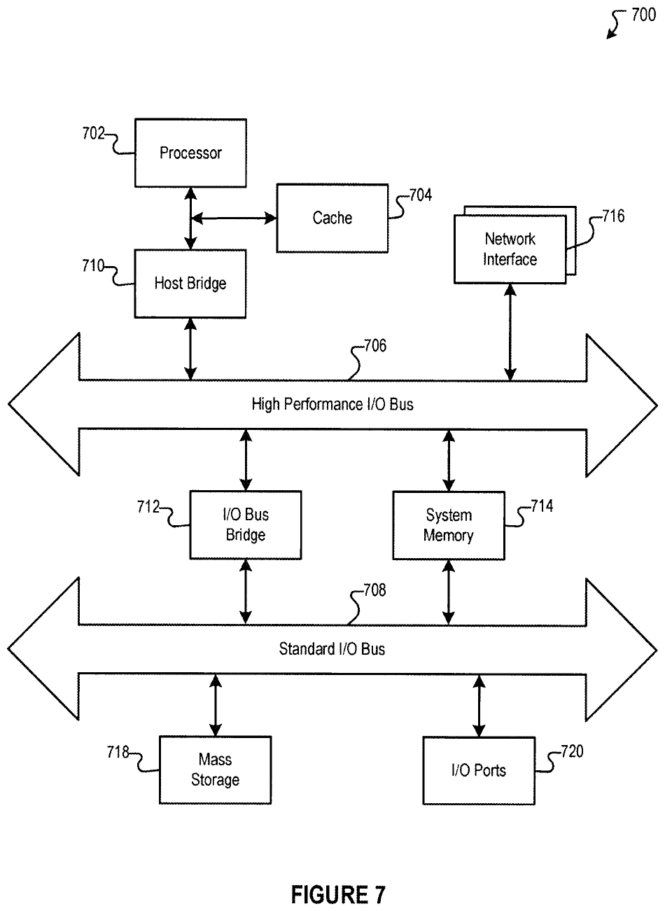

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
receiving, by a server computing system, information describing one or more viewed media content items from a plurality of computing devices in real time through a plurality of persistent network connections as soon as the information is determined by the computing devices, wherein a persistent network connection is established between the server computing system and at least one computing device of the plurality of computing devices after execution of an application associated with the at least one computing device, and wherein the information describing the one or more viewed media content items includes at least a respective viewport view duration for a media content item, a respective viewport view duration for at least one comment associated with the media content item, user interactions performed with respect to the media content item and the at least one comment, and identifications of computing devices from which the media content item and the at least one comment were accessed, wherein the viewport view duration is determined based on an amount of time that the media content item was positioned in a specified portion within a display screen of a computing device from which the media content item was accessed; and
aggregating, by the server computing system, the information describing the one or more viewed media content items, wherein the aggregated information is used to re-rank a set of media content items for one or more users and filter the set of media content items based in part on satisfaction of a threshold view duration.

2. (canceled)

3. (canceled)

4. The computer-implemented method of claim 1, wherein the information describing the one or more viewed media content items further includes a respective viewport view duration for at least one second comment associated with a second media content item and an identification of a second computing device from which the at least one second comment was accessed.

5. The computer-implemented method of claim 4, wherein the respective viewport view duration for the at least one second comment is determined based on an amount of time the at least one second comment was positioned within a viewport region within a display screen of the second computing device from which the at least one second comment was accessed.

6. The computer-implemented method of claim 1, wherein the information describing the one or more viewed media content items further includes respective content types for the one or more viewed media content items.

7. The computer-implemented method of claim 6, wherein a content type identifies a media content item as an image, video, looping video, or audio.

8. The computer-implemented method of claim 1, wherein the plurality of network connections includes a RSocket connection.

9. The computer-implemented method of claim 1, wherein the plurality of network connections between the plurality of computing devices and the server computing system allows the plurality of computing devices to communicate the information to the server computing system as media content items are viewed through the plurality of computing devices.

10. (canceled)

11. A server computing system comprising:
at least one processor; and
a memory storing instructions that, when executed by the at least one processor, cause the server computing system to perform a method comprising:
receiving, through a plurality of network connections, information describing one or more viewed media content items from a plurality of computing devices in real time through a plurality of persistent network connections as soon as the information is determined by the computing devices, wherein a persistent network connection is established between the server computing system and at least one computing device of the plurality of computing devices after execution of an application associated with the at least one computing device, and wherein the information describing the one or more viewed media content items includes at least a respective viewport view duration for a media content item, a respective viewport view duration for at least one comment associated with the media content item, user interactions performed with respect to the media content item and the at least one comment, and identifications of computing devices from which the media content item and the at least one comment were accessed, wherein the viewport view duration is determined based on an amount of time that the media content item was positioned in a specified portion within a display screen of a computing device from which the media content item was accessed; and
aggregating the information describing the one or more viewed media content items, wherein the aggregated information is used to re-rank a set of media content items for one or more users and filter the set of media content items based in part on satisfaction of a threshold view duration.

12. (canceled)

13. (canceled)

14. The computer system of claim 11, wherein the information describing the one or more viewed media content items further includes a respective viewport view duration for at least one second comment associated with a second media content item and an identification of a second computing device from which the at least one second comment was accessed.

15. The computer system of claim 14, wherein the respective viewport view duration for the at least one second comment is determined based on an amount of time the at least one second comment was positioned within a viewport region within a display screen of the second computing device from which the at least one second comment was accessed.

16. A non-transitory computer-readable storage medium including instructions that, when executed by at least one processor of a server computing system, cause the server computing system to perform a method comprising:
receiving information describing one or more viewed media content items from a plurality of computing devices in real time through a plurality of persistent network connections as soon as the information is determined by the computing devices, wherein a persistent network connection is established between the server computing system and at least one computing device of the plurality of computing devices after execution of an application associated with the at least one computing device, and wherein the information describing the one or more viewed media content items includes at least a respective viewport view duration for a media content item, a respective viewport view duration for at least one comment associated with the media content item, user interactions performed with respect to the media content item and the at least one comment, and identifications of computing devices from which the media content item and the at least one comment were accessed, wherein the viewport view duration is determined based on an amount of time that the media content item was positioned in a specified portion within a display screen of a computing device from which the media content item was accessed; and
aggregating the information describing the one or more viewed media content items, wherein the aggregated information is used to re-rank a set of media content items for one or more users and filter the set of media content items based in part on satisfaction of a threshold view duration.

17. (canceled)

18. (canceled)

19. The non-transitory computer-readable storage medium of claim 16, wherein the information describing the one or more viewed media content items further includes a respective viewport view duration for at least one second comment associated with a second media content item and an identification of a second computing device from which the at least one second comment was accessed.

20. The non-transitory computer-readable storage medium of claim 19, wherein the respective viewport view duration for the at least one second comment is determined based on an amount of time the at least one second comment was positioned within a viewport region within a display screen of the second computing device from which the at least one second comment was accessed.

21. The computer-implemented method of claim 1, wherein the information describing the one or more viewed media content items further includes respective user identifiers and respective content identifiers associated with the one or more viewed media content items.

22. The computer-implemented method of claim 21, wherein the information describing the one or more viewed media content item is aggregated based on the user identifiers.

23. The computer-implemented method of claim 21, wherein the information describing the one or more viewed media content item is aggregated based on the content identifiers.

24. The computer-implemented method of claim 1, wherein the user interactions include at least one of likes, comments, or shares of the media content item and the at least one comment.
